(19) United States
(12) Patent Application Publication
(10) Pub. No.: US 2026/0338557 A1
(43) Pub. Date: Oct. 29, 2026

(54) METHOD FOR RECOGNIZING AND CLASSIFYING ELEVATED ROAD MARKINGS

(71) Applicant: Robert Bosch GmbH, Stuttgart (DE)

(72) Inventors: Annette Frederiksen, Renningen (DE); Alf Neustadt, Stuttgart (DE); Arne Josten, Ditzingen (DE); Axel Fink, Tuebingen (DE); Mario Lietz, Vaihingen An Der Enz (DE); Mustafa Kamil, Ludwigsburg (DE); Zoltan Ersek, Korntal-Muenchingen (DE)

(21) Appl. No.: 19/101,609

(22) PCT Filed: Oct. 25, 2023
(86) PCT No.: PCT/EP2023/079734

§ 371 Date: Feb. 6, 2025

(30) Foreign Application Priority Data
Oct. 26, 2022 (DE) 10 2022 211 343.8

(51) Int. Cl. G01C 21/30; G01S 17/89

(52) U.S. Cl. CPC G01C 21/30; G01S 17/89

(57) ABSTRACT

A method for recognizing and classifying elevated road markings using a lidar system of a vehicle. The lidar system includes a transmitting unit, a receiving unit, at least one laser beam source, and at least one detector. The following method steps are carried out individually or in combination: performing a comparison of a map, which contains information about the roadway, with possible elevated road markings to be recognized along the roadway by the lidar system; ascertaining normal road markings from at least one intensity-coded or background-light-coded 3D point cloud and comparing same with possible elevated road markings to be recognized along the roadway by the lidar system; ascertaining context-sensitive information from an accompanying infrastructure or from the traffic-planning relevance of installation locations of elevated road markings and/or analyzing the intensity-coded or background-light-coded 3D point cloud for regular patterns of an arrangement of elevated road markings.

### FIELD

The present invention relates to a method for recognizing and classifying elevated road markings by means of a lidar system of a vehicle. The lidar system includes a transmitting unit, a receiving unit, at least one laser beam source and at least one detector. Furthermore, the present invention relates to the use of the method in a lidar system for the reliable recognition and traversability classification of elevated road markings.

### BACKGROUND INFORMATION

Germany Patent Application No. DE 10 2011 082 477 A1 describes a method and a system for creating a digital image of a vehicle's surrounding area. The system is a driver assistance system for autonomous driving. For this purpose, using a vehicle-based first sensor system, measurement data regarding the vehicle's surrounding area are recorded, and using a vehicle-based video system, at least one marker that is arranged in a fixed position in the vehicle's surrounding area and can be detected optically is recorded. At least one optically detectable characteristic of the at least one marker is recognized from the recording data of the video system and the relative position and orientation of the marker with respect to the vehicle's surrounding area is ascertained.

Europe Patent No. EP 3 529 561 B1 describes a system and a method for generating digital road models from aerial or satellite images and from vehicle-detected data. At least one trajectory of a vehicle for the at least one road section is received in a database external to the vehicle. At least one image that shows at least parts of the at least one road section is received, the image having a perspective that corresponds to an image recorded from an elevated position substantially vertically downwards. The at least one trajectory is then superimposed on the at least one image in such a way that the at least one trajectory corresponds to the course of a road in the at least one image. Subsequently, the at least one image is analyzed in a corridor that extends along and includes the trajectory, and the features of the road section in the corridor that are relevant to driving or positioning are recognized.

Germany Patent Application No. DE 10 2019 106 213 A1 describes a method for determining at least one item of position information of at least one object in a monitoring region using an optical detection device, and to an optical detection device. A method for determining at least one item of position information of at least one object in a monitoring region using an optical detection device and the detection device are described here.

With the method, at least one optical transmission signal with a main transmission signal propagation axis is transmitted into the monitoring region. At least a part of the at least one transmitted signal is reflected as a received signal at an object that is present in the monitoring region and at least a part of the received signal, whose main initial signal propagation axis runs parallel to the main transmission signal propagation axis, at least on the side facing the object, varies.

Current lidar sensor systems use SPAD detectors, with which disadvantages related to the dynamic range of objects of different reflectivity at different distances can arise. The lidar sensor system has the task of reliably recognizing objects with particularly low reflectivity (e.g., 5%) at a large distance, such as 200 m, as well as retroreflectors with particularly high reflectivity (e.g., 10,000%) at a short distance (e.g., a few meters). The resulting dynamic factor between the darkest and the brightest object to be recognized is up to 2000 at the same distance; in addition, there is the signal intensity component, which scales quadratically with distance (exerting a degrading effect). If the lidar sensor system is designed to recognize weakly reflecting objects at the greatest possible distance in line with functional reliability, the probability of optical saturation of the detector with scattered-light-induced false detections, also known as “crosstalk,” increases. This is a significant effect, in particular with close and highly reflective objects. The challenge here is to configure the optical design within the framework of a lidar sensor system consisting of a transmitting and receiving lens, laser diodes and detector pixels so that the dynamic range can be reliably detected.

### SUMMARY

According to the present invention, a method for recognizing and classifying elevated road markings by means of a lidar system of a vehicle is provided, wherein the lidar system includes a transmitting unit, a receiving unit, at least one laser beam source and at least one detector. According to an example embodiment of the present invention, the method includes at least the following method steps, which are carried out individually or in combination:
a) performing a comparison of a map, which contains information about the roadway, with possible elevated road markings to be recognized along the roadway by the lidar system,
b) ascertaining normal road markings from at least one intensity-coded or background-light-coded 3D point cloud and comparing same with possible elevated road markings to be recognized along the roadway by the lidar system,
c) ascertaining context-sensitive information from an accompanying infrastructure or from the traffic-planning relevance of installation locations of elevated road markings and
d) analyzing the intensity-coded or background-light-coded 3D point cloud for regular patterns of an arrangement of elevated road markings.

In an advantageous way, the method proposed according to the present invention can achieve a reliable distinction between false detections produced by elevated road markings and objects that cannot actually be traversed.

In an advantageous development of the solution proposed according to the present invention, according to method step a), a map comparison is carried out based on a geoposition of the vehicle with the map or observations of vehicles driving ahead in a cloud-based database.

In an advantageous development of the method proposed according to the present invention, according to method step d), an approximation of an analytically describable curve or a geometric plane is performed, which is carried out in such a way that the possible elevated road markings to be recognized are suitably associated with one another and a continuous plausibility check is carried out.

Within the framework of the method proposed according to the present invention, according to an example embodiment, in method step d), a regular repetition of possible elevated road markings to be recognized can be advantageously undertaken, in each case at the same distance from one another along the analytically describable curve or the geometric plane.

With the method proposed according to the present invention, according to an example embodiment, in method step d), a circle can be drawn around possible elevated road markings to be recognized, in such a way that intersections of adjacent circles form horizontal, vertical or mutually orthogonal straight lines. Based on the horizontal, vertical or mutually orthogonal straight lines, patterns of road markings can be extrapolated.

In an advantageous development of the method proposed according to the present invention, according to method step d), geometric plausibility checks are performed in order to determine a geometric regularity of the occurrence of elevated road markings for demarcation from individual objects lying on the road.

In an advantageous development of the method proposed according to the present invention, according to method step d), a targeted look-ahead is carried out in such a way that a targeted extrapolation to further elevated road markings is undertaken from the intensity-coded 3D point cloud based on a few visible elevated road markings as a continuation of a recognized geometric regularity.

With the method proposed according to an example embodiment of the present invention, a comparison is undertaken of the intensity-coded 3D point clouds, on the one hand, and the background-light-coded 3D point clouds, on the other hand. An intensity-coded 3D point cloud is a cloud of 3D points with a brightness value corresponding to the received signal of the reflected laser pulse. A background-light-coded 3D point cloud is a cloud of 3D points with a brightness value that corresponds to the brightness of the received background noise signal.

The present invention also relates to the use of the method in a lidar system for the reliable recognition and traversability classification of elevated road markings.

Due to the solution proposed according to the present invention in the form of the method according to the present invention, reliable recognition and traversability classification of elevated road markings is possible. As a result, an accurate distinction can be made between said markings and objects that cannot actually be traversed, such as warning beacons, traffic signs or the like that have a considerable overall height and would inevitably cause damage to the vehicle and its occupants. Due to the solution proposed according to the present invention, it is possible to reliably recognize and classify elevated road markings by analyzing geometric structures, installation patterns, number, spacing and attenuation of optical crosstalk intensity over distance and angle, along with other recurring regularities. It is of decisive importance with the method proposed according to the present invention that an elevated road marking rarely appears alone and free of context. This is understood to mean that an elevated road marking is generally used in conjunction with other elevated road markings and is associated with accompanying infrastructure or traffic-planning relevance with regard to the installation location. Here, examples include hazard zones such as, for example, merging lanes, the proximity of an airport, highway interchanges, construction sites and the like. Due to the solution proposed according to the present invention, a reliable distinction can be made between false detection induced by elevated road markings and objects that cannot actually be traversed, such as warning beacons extending in the vertical direction. Furthermore, the method proposed according to the present invention can achieve a not inconsiderable improvement in the processed point cloud quality after optical crosstalk filtering and thus a considerable improvement in the performance of a lidar sensor system. Due to the solution proposed according to the present invention, any resulting optical crosstalk, i.e., optical interference, can be effectively compensated for after its recognition.

As a result, due to the method proposed according to the present invention, the lidar sensor of a lidar sensor system can generate a crosstalk-free, i.e., interference-free point cloud when elevated road markings occur. Thus, a major source of the optical crosstalk that occurs can be easily and reliably identified.

Due to the use of the method proposed according to the present invention, incorrect braking in automated driving functions can be prevented; furthermore, the absence of braking in front of relevant objects can be avoided, as a result of which traffic safety is increased. Furthermore, due to the use of the method proposed according to the present invention, the occurrence of unwanted braking for non-relevant objects can be prevented, which is also extremely beneficial to traffic safety. Due to the method proposed according to the present invention, data integrity within the 3D point cloud can be supported.

### BRIEF DESCRIPTION OF THE DRAWINGS

Example embodiments of the present invention are explained in greater detail with reference to the figures and the following description.

FIG. 1 shows a vehicle with a lidar system in front of an elevated road marking, a roadway and a 3D point cloud derived from the roadway.

FIG. 1.1 shows the components of a lidar system.

FIG. 2 shows the representation of an elevated road marking, resulting crosstalk ranges and identified ranges of crosstalk and a tolerance range bounded by these.

FIG. 3 shows an exemplary representation of elevated road markings arranged in regular patterns along the lanes of a road describing a curve.

FIG. 4 shows a road narrowing in perspective view bounded on both sides by pairs of elevated road markings, along with an extrapolated continuation of this scene.

FIG. 5 shows a circle consisting of a number of elevated road markings, bounded by two line patterns.

### DETAILED DESCRIPTION OF EXAMPLE EMBODIMENTS

In the following description of example embodiments of the present invention, identical or similar elements are denoted by the same reference signs, and a repeated description of these elements in individual cases is dispensed with. The figures show the subject matter of the present invention only schematically.

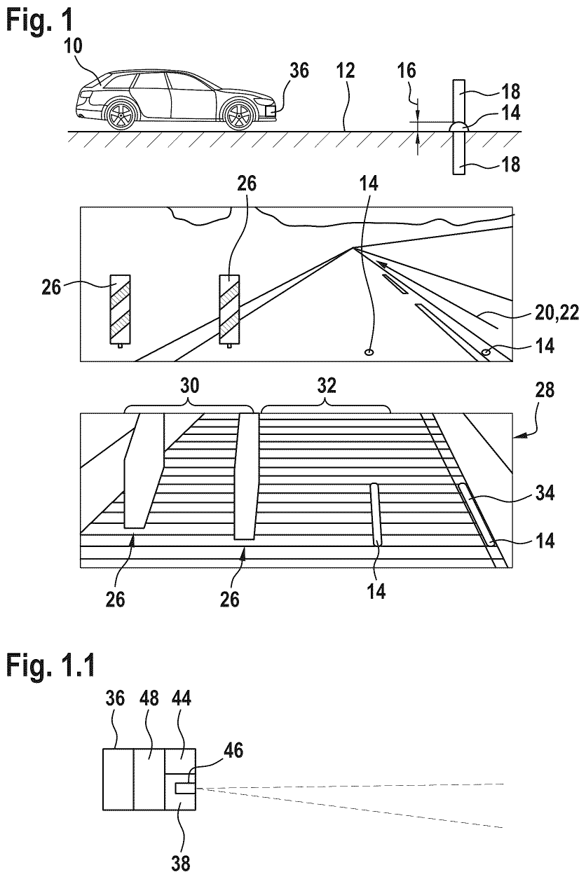

FIG. 1 shows a vehicle 10 that is equipped with a lidar system 36. A road 12 extends in front of the vehicle 10, which road has an elevated road marking 14 within the field of vision of the lidar system 36. This elevated road marking 14 has an overall height 16 that is usually just a few centimeters. Crosstalk ranges 18 extend above the elevated road marking 14.

FIG. 1 also shows a field of view of the scene extending in front of the vehicle 10. A roadway 20 is shown in this scene as a straight line 22. There are warning beacons 26 on the road 12, which extend in a vertical direction from the surface of the road 12. Furthermore, there are two elevated road markings 14 next to the two warning beacons 26 at a distance from one another.

Below the scene of the road 12 in front of the vehicle 10, an intensity-coded or background-light-coded 3D point cloud 28 is shown, which represents the recording of the scene along the roadway 20 by the lidar system 36. From the representation of the intensity-coded or background-light-coded 3D point cloud 28 according to FIG. 1, it can be seen that the warning beacons 26 extending in the vertical direction are shown as objects 30 classified as non-traversable. In contrast, the elevated road markings 14 on the road 12, which are spaced apart from one another in the scene, are shown as objects 32 extending in a horizontal direction, i.e., as distorted objects 34. Despite the relatively low overall height 16 of the elevated road markings 14, they appear as extended objects 32 in the intensity-coded or background-light-coded 3D point cloud 28 and cannot be clearly classified as traversable due to their crosstalk properties.

From the representation according to FIG. 1.1, the components of the lidar system 36 that are installed in the vehicle 10 shown in FIG. 1 can be schematically seen. For example, the lidar system 36 comprises a transmitting unit 38 comprising at least one laser beam source 46. Furthermore, the lidar system 36 comprises a receiving unit 44 that includes a detector 48 onto which radiation reflected from an object detected by the lidar system 36 is bounced. Said lidar system 36 can also comprise other components not shown in detail here and is generally arranged in the vehicle 10 in the front region in order to detect the scene in front of the vehicle 10.

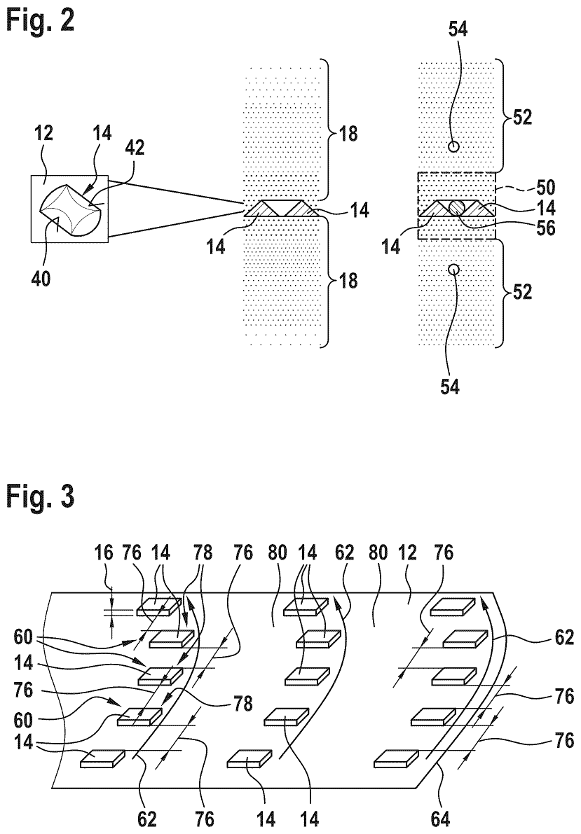

FIG. 2 shows a representation of an elevated road marking 14 and crosstalk ranges (crosstalks) 18 extending therefrom. FIG. 2 shows that the elevated road marking 14 has a first retroreflective surface 40 and a second retroreflective surface 42 opposite it. Said retroreflective surfaces 40, 42 are detected by a lidar system 36 as an intensity-coded or background-light-coded 3D point cloud 28. Crosstalk ranges (crosstalks) 18, which can be divided into a tolerance range 50 and identified crosstalk ranges 52, extend above and below the elevated road marking 14. The identified crosstalk ranges 52 are ranges identified as safe crosstalk ranges 52. Based on the crosstalk ranges 18, it is not possible to recognize whether the elevated road marking 14 can be correctly classified as traversable. Therefore, such a detection by the lidar system 36 would result in unjustified incorrect braking or an unjustified abort of a lane change with the resulting disadvantages for driving experience, trajectory planning and accident safety.

With reference to FIG. 2, it should be noted that outside the tolerance range 50 around the elevated road marking 14, a crosstalk point 54 can be misclassified as an object point 56, which will occur with a probability of less than 5%, for example. Reference sign 56 indicates an object point that is misclassified as optical crosstalk, although the object point 56 is part of the elevated road marking 14. With the object point 56, FIG. 2 visualizes a significant performance requirement, i.e., the object point 56 must be recognized by the lidar system 36. Due to the implementation of the method proposed according to the present invention in a lidar system 36 of the vehicle 10, reliable recognition and traversability classification of elevated road markings 14 is achieved, so that objects 30 that cannot actually be traversed, such as the warning beacons 26 shown in the figure, can be distinguished with certainty. Reliable recognition and reliable traversability classification of elevated road markings 14 can be undertaken, which can be performed by analyzing geometric structures, installation patterns, number, distance and attenuation of crosstalk intensity over distance and angle, along with other regularities. The decisive factor in this connection is the fact that an elevated road marking 14 rarely appears alone or free of context, such as, for example, other elevated road markings 14, an accompanying infrastructure or traffic-planning relevance of installation locations, such as near an airport, in merging areas, at hazard zones or the like.

The method proposed according to the present invention is based on the fundamental approach that elevated road markings 14 rarely appear alone; rather, they occur in arrangements 60 of regular patterns 78, as shown in FIGS. 3, 4 and 5.

In principle, different sources of information can be used for the detection and reliable classification of elevated road markings 14, either individually or in combination in the sense of information fusion.

Thus, according to a method step a), a comparison can be undertaken of a map with information on the course of the road and possible elevated road markings 14 to be recognized on a curve. As a rule, a map comparison is carried out based on the geoposition of the vehicle 10 with the map or by observing vehicles driving ahead, for example via a cloud-based database.

According to method step b), a road marking from an intensity-coded or background-light-coded 3D point cloud 28 is used, and a comparison with elevated road markings 14 that may be recognizable along a curve 24, as shown in FIG. 3, is carried out. According to a method step c), context-sensitive information of an accompanying infrastructure or traffic-planning relevance of installation locations of infrastructure components, for example for hazard zones, to indicate proximity to an airport or hospital, or as an indication of lane mergers, government buildings, tunnels, etc., can be used.

Within the framework of the detection and reliable classification of elevated road markings 14, the intensity-coded or background-light-coded 3D point cloud 28 can also be consulted for the occurrence of regular patterns 78 of arrangements 60 of elevated road markings 14.

For analyzing the intensity-coded or background-light-coded 3D point cloud 28 shown in FIG. 1, for example, a search is carried out for the occurrence of regular patterns 78 within which the elevated road markings 14 are located at certain positions. For example, an approximation of an analytically describable curve 62, as shown in FIG. 3, can be undertaken or a geometric plane 65 can be shown (see FIG. 3), within which the possible elevated road markings 14 to be recognized are suitably associated with one another and a continuous plausibility check is undertaken. The intensity-coded or background-light-coded 3D point cloud 28 can also be examined for regularly occurring repetitions of possible elevated road markings 14 to be recognized, which in each case have the same distance 76 from one another, wherein the regular repetition of possible elevated road markings 14 to be recognized with the same distance 76 from one another can be found along curves 24 or straight lines 22 according to the roadway 20.

Furthermore, for example, within the framework of the analysis of the intensity-coded or background-light-coded 3D point cloud 28, in each case a circle 70 can be conceptually drawn around a possible elevated road marking 14 to be recognized, which circle has a sufficiently large radius so that, from the resulting intersection points of the circles 70, both horizontal and vertical lines are formed that are orthogonal to one another and run parallel to one another.

Within the framework of the above-mentioned method steps a), b), c) and d), a large number of geometric plausibility checks can be applied to the intensity-coded 3D point cloud 28. The aim here is to prove the occurrence of a geometric regularity as a distinguishing feature, for example, with respect to a single lost load lying on the road 12.

Via pattern recognition algorithms and/or matching algorithms, installation patterns of elevated road markings 14 can be generated as clear indicators of these as man-made, artificial infrastructure measures. For example, a speed warning can be surrounded by a circular collection of elevated road markings 14, as shown, for example, in FIG. 5, so that only a correlation of the intensity-coded or background-light-coded 3D point cloud 28 with a circular pattern (see position 70 in FIG. 5) would have to be performed for recognition.

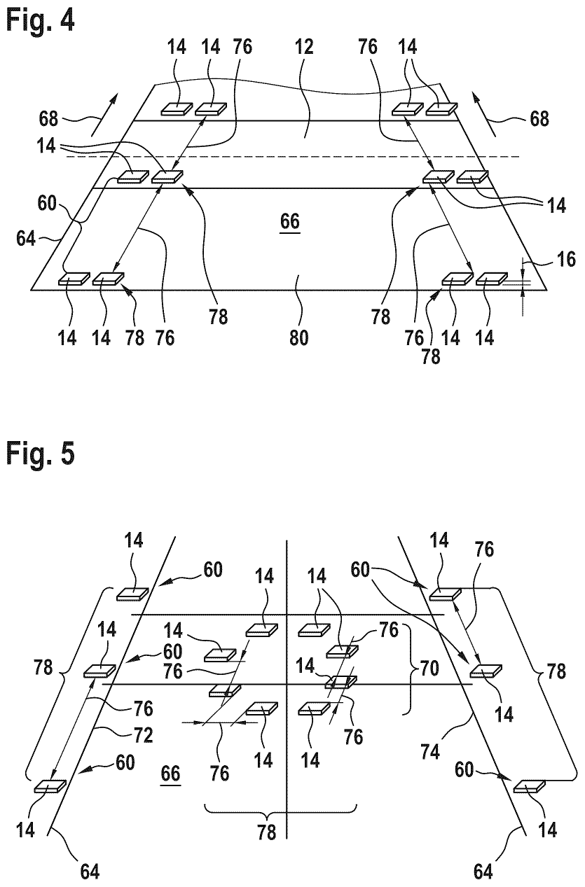

Optical crosstalk 18 itself can also provide reliable information for recognizing elevated road markings 14. The intensity of false detections decreases the viewing angle in the lidar system 36 and over the distance in a manner that is non-linear but analytically describable. Not only can currently available information sources be used for the classification decision, but it is also possible to look ahead in a targeted manner, resulting in an extrapolation 68, as shown in connection with FIG. 4. For the analysis of the intensity-coded or background-light-coded 3D point cloud 28, the extrapolation 68 is derived from a few visible elevated road markings 14, so that a continuation of a geometric regularity once recognized, in the case of FIG. 4 a regular distance 76 between the individual elevated road markings 14 and a gradual reduction in the distance between them, can be inferred, resulting in the extrapolation 68 of the further course of the road 12 indicated in FIG. 4.

It is possible to undertake a comparison of the background-light-coded 3D point cloud with the intensity-coded 3D point cloud 28. Since, in principle, retroreflective surfaces 40, 42 reflect the incident light back in the same direction from which it entered, retroreflective surfaces 40, 42 appear less intense in background-light-coded point clouds 28 than in intensity-coded 3D point clouds 28, since the background light of the former coding is not measured. The sunlight is reflected not to the lidar sensor, but rather back into the sky.

FIG. 3 shows a representation of elevated road markings 14, which are arranged in regular patterns 78 along lanes 80 of the road 12, for example. FIG. 3 shows that the individual elevated road markings 14 have a very low overall height 16; i.e., they represent objects that can be traversed. In the exemplary embodiment according to FIG. 3, the elevated road markings 14 serve as boundaries of lanes 80 of a multi-lane road 12. The individual elevated road markings 14 are provided in an arrangement 60 that is adapted to the curve 24 of the individual lanes 80 of the road 12, and have a regular distance 76 from one another. In the vertical direction, the individual elevated road markings 14 are evenly spaced from one another and in this connection serve as boundaries of the individual lanes 80 of the road 12. The arrangement 60 of the individual elevated road markings 14 is carried out in the representation according to FIG. 3 of an analytically describable curve 62. The road 12 having a number of lanes 80 separated from one another by the regular patterns 78 of elevated road markings 14 is bounded by a road edge 64 on the right side.

In contrast to the representation according to FIG. 3, a geometric plane 65 is indicated in the representation according to FIG. 4, which plane represents a straight course 22 of the road 12. FIG. 4 shows that the elevated road markings 14 arranged in pairs on the right and left in the geometric plane 65 are arranged at identical distances 76 from one another. From the regular pattern 78 according to FIG. 4, an extrapolation 68 can be obtained from the geometric plane 65, which continues the recognized regular pattern 78 of the arrangement 60 according to the straight course 22 along the road 12. Thus, by means of extrapolation 68, further information with respect to the route further ahead of the vehicle 10, i.e., the road 12, can be obtained from a few visible elevated road markings 14.

FIG. 5 shows a geometric plane 65, which is bounded by a first line pattern 72 on the left side and by a second line pattern 74 on the right side. It can be seen from the representation according to FIG. 5 that the individual elevated road markings 14 are arranged along the first line pattern 72 and the second line pattern 74 in regular patterns 78 with an identical distance 76 from one another. In the center, for example, between the two line patterns 72, 74, a circle 70 of individual elevated road markings 14 arranged in a regular pattern 78 is shown. In relation to the pattern of the circle 70, the individual elevated road markings 14 have an identical distance 76 from one another.

The present invention is not limited to the embodiments described here and the aspects emphasized therein. Rather, based on the disclosure herein, a large number of modifications are possible, which are within the scope of the activities of a person skilled in the art.

1-10. (canceled)

11. A method for recognizing and classifying elevated road markings using a lidar system of a vehicle, wherein the lidar system including a transmitting unit, a receiving unit, at least one laser beam source, and at least one detector, the method comprising the following method steps, which are carried out individually or in combination:
a) performing a comparison of a map, which contains information about a roadway with possible elevated road markings to be recognized along the roadway by the lidar system;
b) ascertaining normal road markings from at least one intensity-coded or background-light-coded 3D point cloud and comparing the ascertaine normal road markings with the possible elevated road markings to be recognized along the roadway by the lidar system;
c) ascertaining context-sensitive information from an accompanying infrastructure or from a traffic-planning relevance of installation locations of elevated road markings, and/or d) analyzing the intensity-coded or background-light-coded 3D point cloud for regular patterns of an arrangement of elevated road markings.

12. The method according to claim 11, wherein, according to method step a), a map comparison is performed based on a geoposition of the vehicle with the map or observations of vehicles driving ahead in a cloud-based database.

13. The method according to claims 11, wherein, according to method step d), an approximation of an analytically describable curve or a geometric plane is performed in such a way that the possible elevated road markings to be recognized are suitably associated with one another and a continuous plausibility check is carried out.

14. The method according to claim 13, wherein, according to method step d), a regular repetition of the possible elevated road markings to be recognized is undertaken in each case at the same distances from one another along the analytically describable curve or the geometric plane.

15. The method according to claim 11, wherein, according to method step d), circles are drawn around the possible elevated road markings to be recognized, in such a way that intersections of adjacent circles form horizontal, vertical and mutually orthogonal straight lines.

16. The method according to claim 11, wherein, according to method step d), geometric plausibility checks are performed in order to determine a geometric regularity of an occurrence of elevated road markings, and demarcation from individual objects lying on the roadway is carried out.

17. The method according to claim 11, wherein, according to method step d), a targeted look-ahead is carried out in such a way that a targeted extrapolation to further elevated road markings is undertaken from the intensity-coded or background-light-coded 3D point cloud based on a few visible elevated road markings as a continuation of a recognized geometric regularity.

18. The method according to claim 11, wherein a comparison is undertaken of the intensity-coded 3D point cloud with the background-light-coded 3D point cloud.

19. The method according to claim 11, wherein crosstalk effects are minimized by comparing the background-light-coded point cloud with the intensity-coded point cloud in the case of signs of an infrastructure.

20. The method according to claim 11, wherein the lidar system is used for reliable recognition and traversing classification of elevated road markings.
